(19) United States
(12) Patent Application Publication
(10) Pub. No.: US 2010/0187963 A1
(43) Pub. Date: Jul. 29, 2010

(54) Heat Sink for Passive Cooling of a Lamp

(76) Inventor: Guy Vaccaro, Warrenville, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/695,066

(22) Filed: Jan. 27, 2010

Related U.S. Application Data
(60) Provisional application No. 61/206,195, filed on Jan. 28, 2009.

(51) Int. Cl. H01J 61/52; F28F 7/00; G06F 1/20

(52) U.S. Cl. 313/46; 165/80.3; 165/185; 165/121

(57) ABSTRACT

Various embodiments of heat sinks for passive cooling of lamps are provided. In an embodiment, a heat sink comprises a top end and a bottom end that is opposite the top end along a body axis of the heat sink, an airflow passageway formed through the heat sink, an internal surface that defines the airflow passageway, and an external surface. The airflow passageway extends in general alignment with the body axis from substantially the top end of the heat sink to substantially the bottom end of the heat sink, and the airflow passageway comprises at least one airflow opening located substantially at the top end of the heat sink and at least one airflow opening located substantially at the bottom end of the heat sink.

### CROSS-REFERENCE TO RELATED APPLICATIONS

This application claims the benefit of U.S. Provisional Patent Application No. 61/206,195, filed on Jan. 28, 2009, and titled “Vented LED Lamp with Passive Cooling.”

### BACKGROUND

Electric lamps are used throughout the world to provide light. Depending on its design and intended use, a lamp may include one or more lighting elements (or light sources). The most common lighting elements include incandescent lighting elements, fluorescent lighting elements, and light emitting diodes (LEDs). All lighting elements, whether incandescent, fluorescent, or LED, convert electric power into radiant energy and heat in various proportions. The heat generated by lighting elements may adversely affect the lighting elements themselves. For instance, heat may reduce the light output as well as the life of an LED. In addition, lighting elements in a lamp may be further adversely affected by heat that may be generated by other electrical components of the lamp.

Due to the possible adverse effects on lighting elements caused by heat, lamps are often designed to dissipate heat via radiation, convection (passive or active (i.e., forced)), conduction, or some combination thereof. For instance, LED lamps often employ heat sinks. These heat sinks may be formed of various materials, the most likely materials being conductive ones. (Herein, “conductive” is generally meant to refer to thermally conductive, however, it is not meant to exclude electrically conductive.) Additionally, heat sinks may be anodized and/or coated to increase their emissive properties (i.e., increase heat dissipation via radiation), increase their durability, improve their aesthetic appeal, etc. Further, heat sinks may include physical structures such as fins that are designed to increase the surface area over which heat can be dissipated, as is known in the art.

### Overview

Disclosed herein are various embodiments of heat sinks, as well as various embodiments of lamps making use of such heat sinks. As disclosed, the heat sink is designed such that it includes an airflow passageway to help dissipate heat that may be generated by various electrical components, including lighting elements (e.g., LEDs), of the lamp. The heat sink dissipates generated heat at least by conduction, passive convection, and radiation. By dissipating generated heat, the light output and life of the lighting elements (e.g., LEDs) may not decrease as they otherwise might without such heat dissipation. Further, by dissipating heat in this manner, more power may be delivered for use by the lighting elements, which may translate to greater light output.

One embodiment of the heat sink comprises (i) a top end and a bottom end that is opposite the top end along a body axis of the heat sink, (ii) an airflow passageway formed through the heat sink, the airflow passageway extending in general alignment with the body axis from substantially the top end of the heat sink to substantially the bottom end of the heat sink, the airflow passageway comprising at least one airflow opening located substantially at the top end of the heat sink and at least one airflow opening located substantially at the bottom end of the heat sink, (iii) an internal surface that defines the airflow passageway, and (iv) an external surface.

The heat sink may be configured to receive electronics. In one example, the heat sink may further comprise an electronics mount positioned substantially at the top end of the heat sink, the electronics mount comprising a portion that is sized and shaped to receive an electronics module. The electronics mount may be configured such that at least some heat generated by the electronics module is transferred to the heat sink. Additionally, the electronics mount may comprise an annular flange arranged about the airflow passageway and extending radially from the external surface of the heat sink. Further, the electronics mount may comprise a rim that extends from the annular flange and is generally aligned with the body axis, the rim comprising an outer surface. Even further, the electronics mount may comprise at least one spacer extending radially from the outer surface of the rim. The spacer may help center the heat sink when, as one example, a lamp comprising the heat sink is installed in a fixture.

The above-mentioned electronics module may comprise various electronics. In one example, the electronics module may comprise at least one lighting element. In this and in all examples disclosed herein, the at least one lighting element may comprise at least one LED. In another example, the electronics module comprises a circuit board on which the at least one lighting element is arranged, the circuit board comprising circuitry electrically connected to the at least one lighting element.

In one example, the heat sink may further comprise a deflector positioned substantially at the bottom end of the heat sink. Note that, by convention, the end referred to herein as the “bottom end” would be the higher end in a substantially vertical installation, while the end referred to herein as the “top end” would be the lower end in such an installation. The deflector may generally have a shape of a plate, a cone, or a cup, among a multitude of other alternatives. Regardless of the general shape, the deflector may be sized and shaped to receive a base for receiving input electrical power. The base may comprise at least one of an Edison-type base and a GU-type base. Alternatively, or in addition to being sized and shaped to receive a base, the deflector may be sized and shaped to receive electronics for conditioning input electrical power and for delivering conditioned electrical power for use by at least one lighting element.

To help dissipate heat, the heat sink may further comprise internal fins. In one example, the heat sink may comprise a plurality of internal fins attached to and in thermal contact with the internal surface and extending therefrom. The alignment of the internal fins may vary. For instance, the internal fins may be generally aligned with the body axis. Regardless of alignment, the arrangement of the internal fins may vary. For instance, at least one of the internal fins may span the airflow passageway. Alternatively, at least one of the internal fins may not span the airflow passageway. And certainly other alignments and arrangements are possible.

The heat sink may also comprise external fins to help dissipate heat. In one example, the heat sink may comprise a plurality of external fins attached to and in thermal contact with the external surface and extending radially therefrom. Like the internal fins, the orientation and arrangement of the external fins may vary. For instance, each external fin may lie in a different plane, each plane being generally normal to the body axis. In addition, each external fin may have a diameter, where the external fins generally have diameters less than that of any external fins that are closer to the top end of the heat sink. Further, regardless of the form or shape they may take, the external fins may be spaced regularly or irregularly along a length of the heat sink between the top end of the heat sink and the bottom end of the heat sink. In some embodiments, each external fin may lie in a different plane, each plane being generally aligned with the body axis. And certainly other arrangements are possible.

The airflow passageway may take various forms. In one example, the airflow passageway may be a single passageway. Accordingly, the at least one airflow opening located substantially at the top end of the heat sink may consist of a single airflow opening, and the at least one airflow opening located substantially at the bottom end of the heat sink may likewise consist of a single airflow opening. Further, the airflow opening located substantially at the top end of the heat sink may be larger than the airflow opening located substantially at the bottom end of the heat sink.

In another example, the airflow passageway may comprise a plurality of passageways that are each generally aligned with the body axis. In such an example, the at least one airflow opening located substantially at the top end of the heat sink may consist of a respective airflow opening for each passageway. The at least one airflow opening located substantially at the bottom end of the heat sink may similarly consist of a respective airflow opening for each passageway. Further, each passageway's airflow opening located substantially at the top end of the heat sink may be larger than that passageway's airflow opening located substantially at the bottom end of the heat sink. However, the at least one airflow opening located substantially at the bottom end of the heat sink may consist of a single airflow opening. In such an embodiment, the plurality of passageways may merge somewhere between the airflow openings located substantially at the top end and the single airflow opening located substantially at the bottom end of the heat sink.

The heat sink may be made of many different materials or combinations of materials. In one example, the heat sink is made at least in part of a conductive material. The conductive material may comprise at least one material selected from the group consisting of aluminum, iron, copper, silver, gold, magnesium, zinc, and alloys thereof. In addition, the heat sink may be anodized. Regardless of whether the heat sink is anodized, the heat sink may be coated with a material such as paint.

To help dissipate heat even further, active (i.e., forced) convection may be used. In one example, the bottom end of the heat sink may be sized and shaped to receive a partially mechanical device for accelerating air flow. The partially mechanical device may comprise a fan. And certainly other partially mechanical devices are possible.

Another disclosed embodiment of a heat sink comprises (i) a top end and a bottom end that is opposite the top end along a body axis of the heat sink, (ii) a single airflow passageway formed through the heat sink, the airflow passageway extending in general alignment with the body axis from substantially the top end of the heat sink to substantially the bottom end of the heat sink, the airflow passageway having a single airflow opening located substantially at the top end of the heat sink and a single airflow opening located substantially at the bottom end of the heat sink.

In this embodiment, the heat sink further comprises (iii) an internal surface that defines the airflow passageway, (iv) an external surface, (v) a plurality of internal fins attached to and in thermal contact with the internal surface and extending therefrom, (vi) a plurality of external fins attached to and in thermal contact with the external surface and extending radially therefrom, (vii) a deflector positioned substantially at the bottom end of the heat sink, and (viii) an electronics mount positioned substantially at the top end of the heat sink, the electronics mount comprising a portion that is sized and shaped to receive an electronics module, the electronics mount being configured such that at least some heat generated by the electronics module is transferred to the heat sink.

In one example, the airflow opening located substantially at the top end of the heat sink may be larger than the airflow opening located substantially at the bottom end of the heat sink.

An embodiment of a lamp comprises: (i) a heat sink that may take the form of one of the above-described heat sinks; (ii) an electronics module positioned substantially at the top end of the heat sink, wherein the electronics module comprises at least one lighting element, and is configured such that at least some heat generated by the electronics module is transferred to the heat sink; (iii) a base for receiving input electrical power, wherein the base is positioned substantially at the bottom end of the heat sink; (iv) electronics for conditioning the input electrical power and for delivering conditioned electrical power for use by the at least one lighting element; and (v) at least one electrical connection for transmitting the conditioned electrical power to the at least one lighting element.

The lamp may further comprise an optical lens to help focus and shape the light distribution from the at least one lighting element. In one example, the optical lens may be positioned substantially at the top end of the heat sink, where the optical lens at least substantially covers the at least one lighting element, which may take the form of a plurality of (e.g., seven) lighting elements (e.g., LEDs).

The electronics module may comprise various electronics. In one example, the electronics module may comprise a circuit board on which the at least one lighting element is arranged, the circuit board comprising circuitry electrically connected to the at least one lighting element.

The base may vary depending on the type of socket with which the lamp is designed to be used. In one example, the base may comprise at least one of an Edison-type base and a GU-type base. Regardless of the type of base, the base may be configured to receive various electronics. In one example, the base may be sized and shaped to receive the electronics for conditioning the input electrical power and for delivering conditioned electrical power for use by the at least one lighting element. Additionally, those electronics may be positioned at least partially in the base.

In addition to taking advantage of passive heat dissipation, various embodiments of the lamp may also use active (i.e., forced) heat dissipation. For example, the lamp may comprise a partially mechanical device for accelerating air flow, the partially mechanical device positioned substantially at the bottom end of the heat sink. The partially mechanical device may comprise a fan.

And it is expressly contemplated that any alternative, permutation, or other variation or feature of any disclosed embodiment may apply to any other embodiment, to the extent that alternative, permutation, or other variation or feature would be consistent and compatible with such other embodiment. In other words, disclosure of a given alternative, permutation, or other variation or feature of a heat sink, a lamp, and/or any other component or collection of components in connection with a given embodiment thereof is in no way intended to be limited to that given embodiment. Furthermore, it should be noted that the above overview is intended to be illustrative and not limiting.

### BRIEF DESCRIPTION OF THE DRAWINGS

Various exemplary embodiments are described herein with reference to the following drawings, wherein like numerals denote like entities.

FIG. 1A is a side view of a heat sink.

FIG. 1B is a side view of a heat sink.

FIG. 2A is a cross-sectional side view of the heat sink of FIG. 1A.

FIG. 2B is a cross-sectional side view of a heat sink.

FIG. 3A is a side view of the deflector of the heat sink of FIGS. 1A-2B.

FIG. 3B is a side view of a deflector of a heat sink.

FIG. 3C is a side view of a deflector of a heat sink.

FIG. 4A is a top view of the internal fins of the heat sink of FIGS. 1A and 2A.

FIG. 4B is a top view of internal fins of a heat sink.

FIG. 4C is a top view of internal fins of a heat sink.

FIG. 5 is an exploded view of a lamp comprising the heat sink of FIGS. 1A and 2A.

FIG. 6A is a side view of the Edison-type base of the lamp of FIG. 5.

FIG. 6B is a side view of a GU-type base of a lamp.

FIG. 7A is a top view of the lamp of FIG. 5.

FIG. 7B is a top view of a lamp.

FIG. 8A is a top view of a lamp.

FIG. 8B is a top view of a lamp.

FIG. 9 is a cross-sectional side view of the lamp of FIG. 5 installed in a fixture.

### DETAILED DESCRIPTION

### A. Exemplary Structure

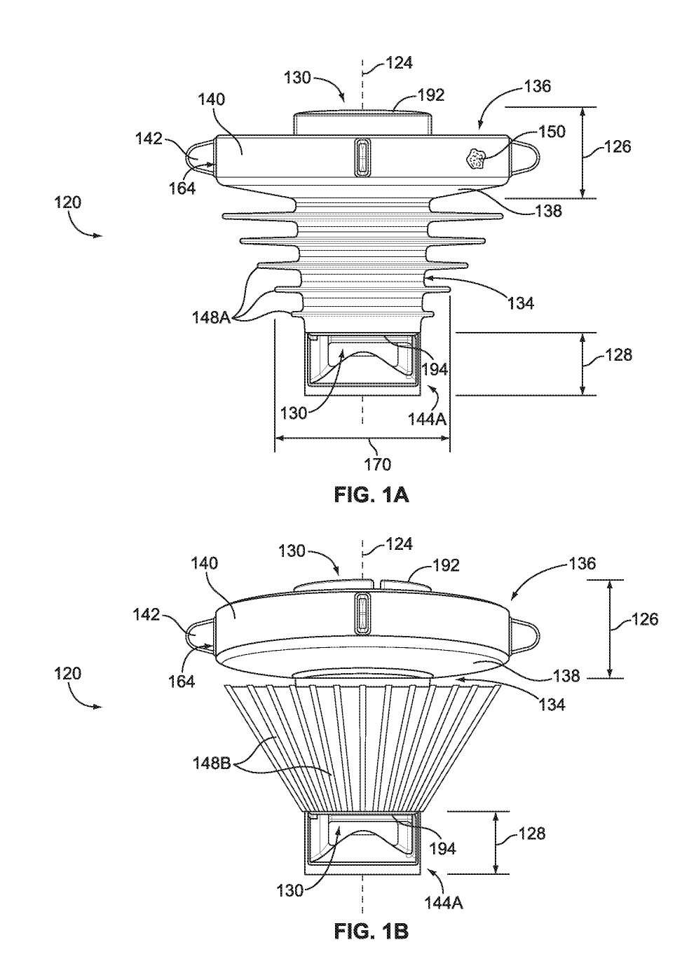

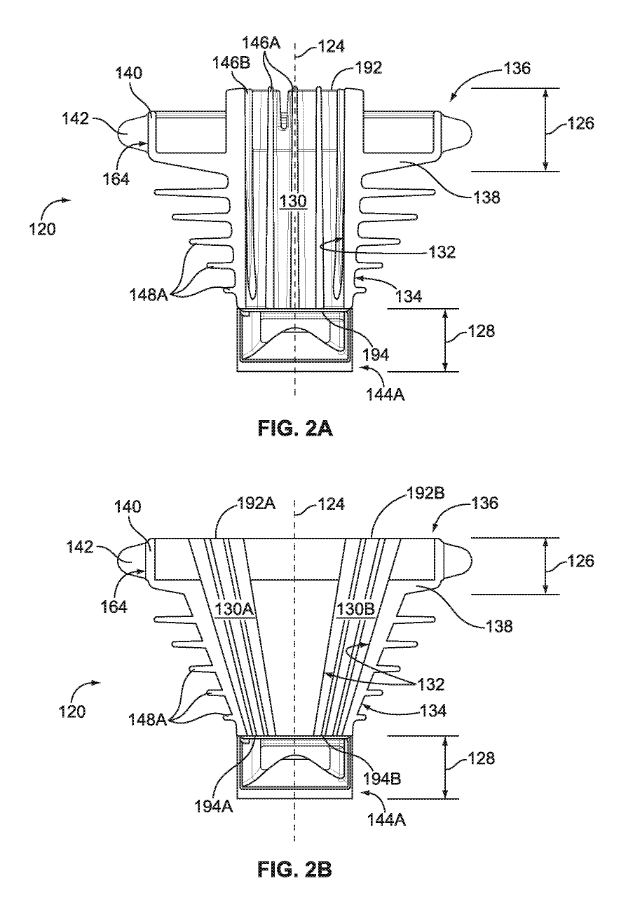

A heat sink is identified in the accompanying drawings at 120. Referring to FIGS. 1A and 2A, one embodiment of a heat sink 120 generally comprises a top end 126 and a bottom end 128 that is opposite the top end 126 along a body axis 124 of the heat sink 120. The heat sink 120 also comprises an airflow passageway 130 formed through the heat sink 120, the airflow passageway 130 extending in general alignment with the body axis 124 from substantially the top end 126 to substantially the bottom end 128 of the heat sink 120. The airflow passageway 130 comprises one airflow opening 192 located substantially at the top end 126 of the heat sink 120 and one airflow opening 194 located substantially at the bottom end 128 of the heat sink 120. The airflow opening 192 located substantially at the top end 126 of the heat sink 120 is larger than the airflow opening 194 located substantially at the bottom end 128 of the heat sink 120.

As best shown in FIG. 2A, an internal surface 132 defines the airflow passageway 130. Extending from the internal surface 132, and in thermal contact therewith, are a plurality of internal fins 146A, 146B, as best shown in FIG. 4A. The plurality of internal fins 146A, 146B comprises six internal fins 146B (only two are visible) that do not span the passageway 130 and three internal fins 146A that span the passageway 130. The view of the plurality of internal fins 146A, 146B that is shown in FIG. 4A is just one embodiment of a heat sink 120. In other embodiments, the arrangement of the internal fins 146A, 146B may vary. FIG. 4B and FIG. 4C show two other arrangements. As shown in FIG. 4B, none of the internal fins 146B span the passageway 130. In FIG. 4C, however, all of the internal fins 146A span the passageway 130. Additionally, the number of internal fins 146A, 146B may vary from one embodiment to another. And certainly many other arrangements are possible.

As best shown in FIG. 1A, the heat sink 120 also comprises an external surface 134. Extending from the external surface 134, and in thermal contact therewith, are a plurality of external fins 148A. Each of the external fins 148A lie in a different plane, each plane being generally normal to the body axis 124. Additionally, each of the external fins 148A has a diameter 170, where the external fins 148A of the heat sink 120 generally have diameters 170 that are less than that of any external fins 148A that are closer to the top end 126 of the heat sink 120. Further, the external fins 148A are spaced regularly along a length 172 of the heat sink 120 between the top end 126 and the bottom end 128 of the heat sink 120. Other embodiments of heat sinks 120 may comprise external fins 148A, 148B that are arranged and/or shaped differently. For instance, in another embodiment, as shown in FIG. 1B, each external fin 148B lies in a different plane, where each plane is generally aligned with the body axis 124. And certainly many other arrangements are possible.

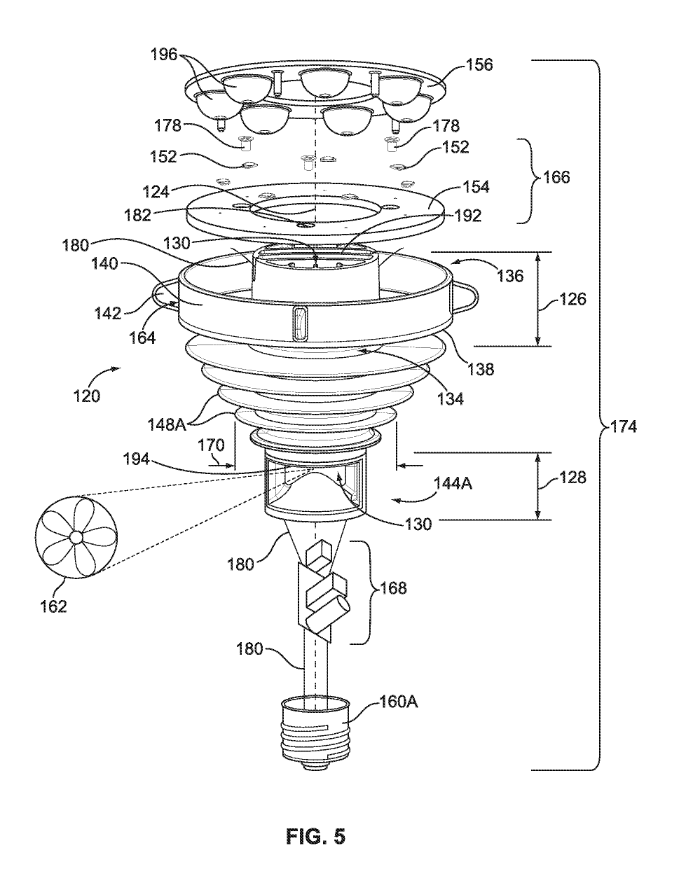

Also as shown in FIG. 1A, the heat sink 120 comprises an electronics mount 136 positioned substantially near the top end 126 of the heat sink 120 that is sized and shaped to receive an electronics module such as the module 166 shown in FIG. 5. The electronics mount 136 is positioned such that at least some heat generated by the electronics module 166 is transferred to the heat sink 120. In addition, the electronics mount 136 comprises an annular flange 138 arranged about the airflow passageway 130 that extends radially from the external surface 134 of the heat sink 120. Further, the electronics mount 136 comprises a rim 140 that extends from the annular flange 138. The rim 140 is generally aligned with the body axis 124. Even further, the heat sink 120 comprises four spacers 142 (only three are visible) that extend radially from an outer surface 164 of the rim 140.

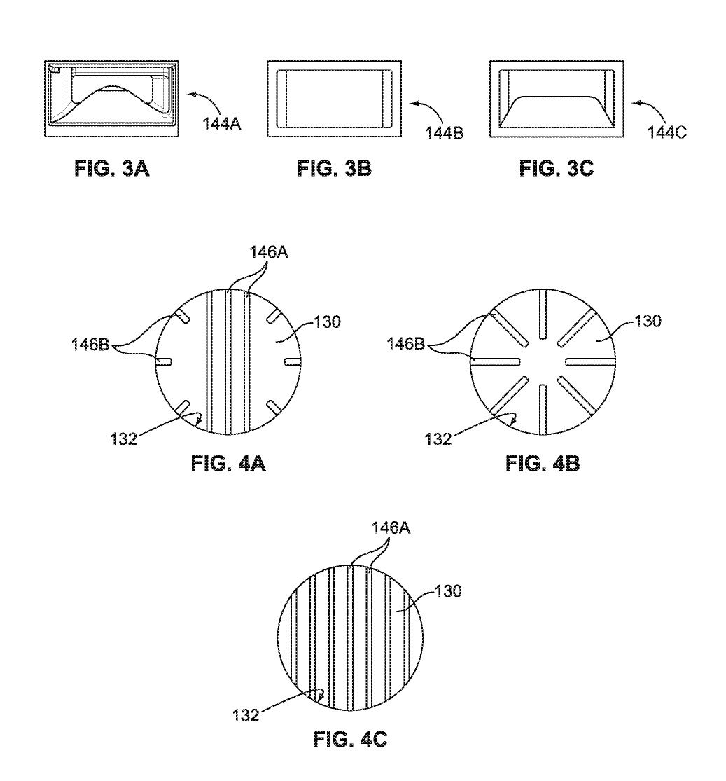

As best shown in FIG. 1A, the heat sink 120 also comprises a deflector 144A positioned substantially at the bottom end 128 of the heat sink 120. In the depicted embodiment, the deflector 144A generally has the shape of a cone. A closer view of the deflector 144A is shown in FIG. 3A. Other embodiments may comprise a deflector 144B that generally has the shape of a plate as shown in FIG. 3B. Still, other embodiments may comprise a deflector 144C that generally has the shape of a cone as shown in FIG. 3C. And certainly many other deflector shapes are possible.

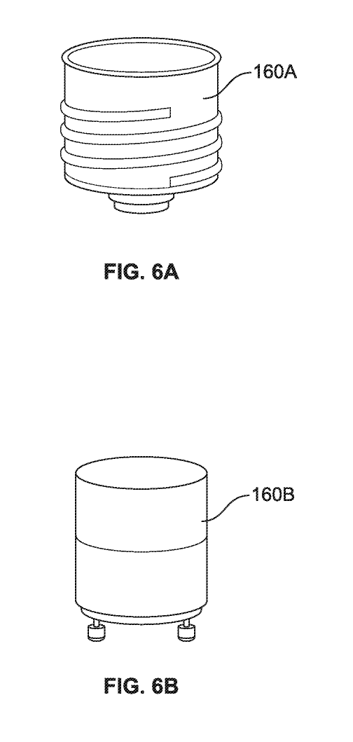

Referring to FIG. 5, the deflector 144A is sized and shaped to receive an Edison base 160A for receiving input electrical power, and to receive electronics 168 for conditioning the input electrical power and for delivering conditioned electrical power to the electronics module 166. Other embodiments may comprise a deflector 144A, 144B, 144C that is sized and shaped to receive a different type of base such as the GU-type base 160B shown in FIG. 6B, or perhaps some other alternative.

And it is expressly contemplated that one or more embodiments may include additional features instead of and/or in addition to those depicted in these figures, and that one or more embodiments may include some but not all of the features depicted in those figures.

For instance, as shown in FIG. 2B, an embodiment of a heat sink 120 comprises an airflow passageway 130 that comprises two passageways 130A, 130B that are each generally aligned with the body axis. Further, the two passageways 130A, 130B each comprise a respective airflow opening 192A, 192B located substantially at the top end 126 and a respective airflow opening 194A, 194B located substantially at the bottom end 128 of the heat sink 120. In an embodiment, the airflow openings 192A, 192B located substantially at the top end 126 are larger than the airflow openings 194A, 194B located substantially at the bottom end 128 of the heat sink 120.

And it is expressly contemplated that an airflow passageway comprising a plurality of passageways 130A-130N (where N is an integer) does not necessarily have to comprise a respective airflow opening 194A-194N located substantially at the bottom end 128 of the heat sink 120 for each of the passageways 130A-130N. This may occur if, for example, the passageways 130A-130N merge within the heat sink 120. However, it should be noted that even with merger, each passageway 130A-130N is generally aligned with the body axis 124 of the heat sink 120. Additionally, each of the airflow openings 192A-192N located substantially at the top end 126 does not have to be larger than each corresponding airflow opening 194A-194N located substantially at the bottom end 128 of the heat sink 120.

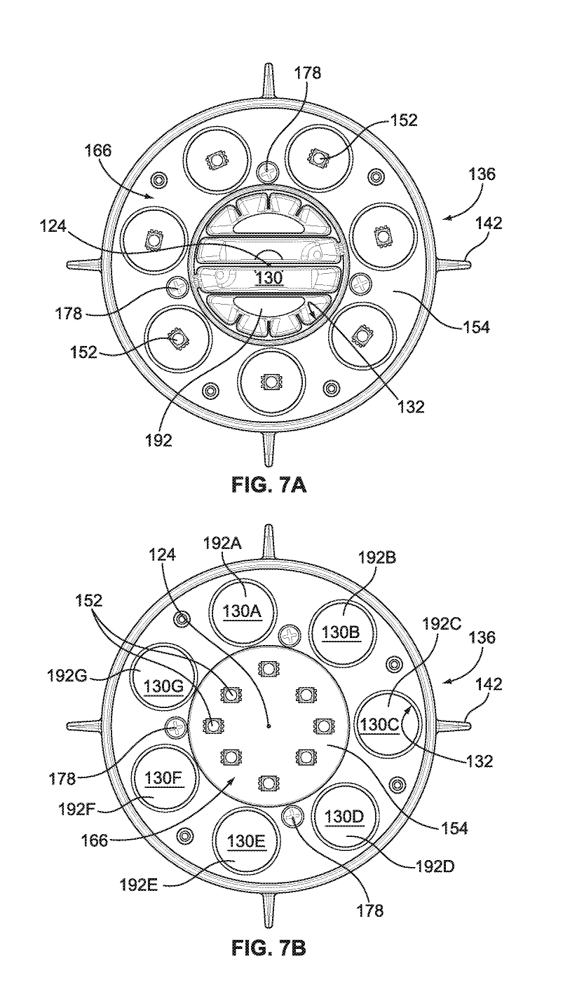

FIG. 7A shows the airflow passageway 130 of the embodiment shown in FIG. 1A and FIG. 2A discussed above. The airflow passageway 130 is formed through the center of the heat sink 120 and comprises a single airflow opening 192 located substantially at the top end 126 of the heat sink 120. Accordingly, the body axis 124 runs through the airflow opening 192.

FIG. 7B shows an embodiment where the airflow passageway 130 comprises a plurality of passageways 130A-130G each having a respective airflow opening 192A-192G located substantially at the top end 126 of the heat sink 120. The airflow openings 192A-192G are arranged around the body axis 124.

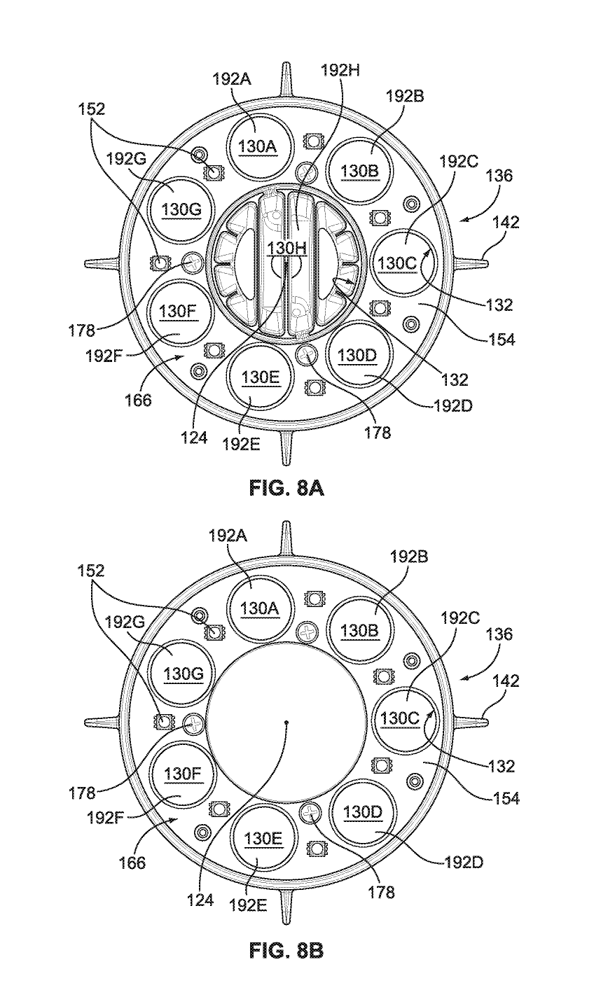

FIG. 8A shows an embodiment where the airflow passageway comprises a plurality of passageways 130A-130H each having a respective airflow opening 192A-192H located substantially at the top end 126 of the heat sink 120. The body axis 124 runs through one of the airflow openings 192H, however, the remaining airflow openings 192A-192G are arranged around the body axis 124 as in FIG. 7B.

A lamp is identified in the accompanying drawings at 174. Referring to FIG. 5, one embodiment of a lamp 174 generally comprises six main components, which of course, may be combined or rearranged, as is known in the art, to make more or less than six components. The six main components include (i) a heat sink 120 such as that described above in connection with FIGS. 1A and 2A, (ii) an electronics module 166, (iii) a base 160A for receiving input electrical power, (iv) electronics 168 for conditioning the input electrical power and for delivering conditioned electrical power, (v) at least one electrical connection 180 for transmitting the conditioned electrical power, and (vi) an optical lens 156.

As best shown in FIG. 5 and FIG. 7A, the electronics module 166 may be positioned substantially at the top end 126 of the heat sink 120. In the depicted embodiment, the electronics module 166 comprises seven lighting elements 152, such as light emitting diodes (LEDs), and a circuit board 154 on which the seven lighting elements 152 are arranged. Additionally, the circuit board 154 comprises circuitry (not shown) electrically connected to the seven lighting elements 152. In other embodiments, the electronics module 166 may comprise additional electronics such as electronics for conditioning (or perhaps further conditioning) electrical power.

As best shown in FIG. 7A, the seven lighting elements 152 are arranged in a radial pattern around the airflow opening 192 located substantially at the top end 126 of the heat sink 120. However, in other embodiments, including those shown in FIGS. 7B, 8A, and 8B, the lighting elements 152 may be arranged differently depending on the location of the airflow passageways 130A-130N and their respective airflow openings 192A-192N located substantially at the top end 126 of the heat sink 120.

The electrical power requirements of the electronics module 166 are generally determined by the electrical characteristics of the particular lighting elements 152 and the circuitry. For instance, a typical LED operates at a few volts and at a few hundred milliamperes or less. The electronics module 166 shown in FIGS. 5 and 7A is attached to the electronics mount 136 of the heat sink 120 with three screws 178 and a thermal interface material (not shown). In other embodiments, however, a different number of screws 178 or one or more other fastening means may be used. Further, thermal interface material may not be used. And other arrangements are certainly possible.

Also, as shown in FIG. 5, the base for receiving input electrical power is an Edison type base 160A that is threaded. However, other embodiments may use a different base such as a GU-type base 160B comprising two prongs as shown in FIG. 6B.

FIG. 5 also shows the electronics 168 for conditioning the input electrical power and for delivering conditioned electrical power for use by the lighting elements 152. Such electronics 168 may comprise a driver that reduces the voltage, converts the current from alternating current (AC) to direct current (DC), and adjusts the current to the designed output according to the power requirements of a given implementation. The conditioned electrical power is delivered for use by the lighting elements 152 via two electrical connections 180. As shown in FIG. 5, the electronics 168 are positioned substantially near the bottom end 128 of the heat sink 120. However, at least a portion of the electronics 168 may be positioned elsewhere, such as substantially at the top end 126 of the heat sink 120. In such an embodiment, the electronics module 166 may comprise at least a portion of the electronics 168. And other configurations are certainly possible.

As best shown in FIG. 5, in the depicted embodiment, the optical lens 156 is positioned substantially at the top end 126 of the heat sink 120 and covers the lighting elements 152. In the depicted embodiment, the optical lens 156 further comprises individual lenses 196 respectively corresponding to the individual lighting elements 152, though this is not necessary in all embodiments. In some embodiments, the optical lens 156 may comprise additional optical components for focusing, shaping, filtering, and polarizing the light. And the possible configurations abound, as known to those in the art. Other embodiments of a lamp 174 may include additional features instead of and/or in addition to those depicted in FIGS. 1A, 2A, 5, and 7A. Also, other embodiments may include some but not all of the features depicted in these figures.

### B. Exemplary Operation

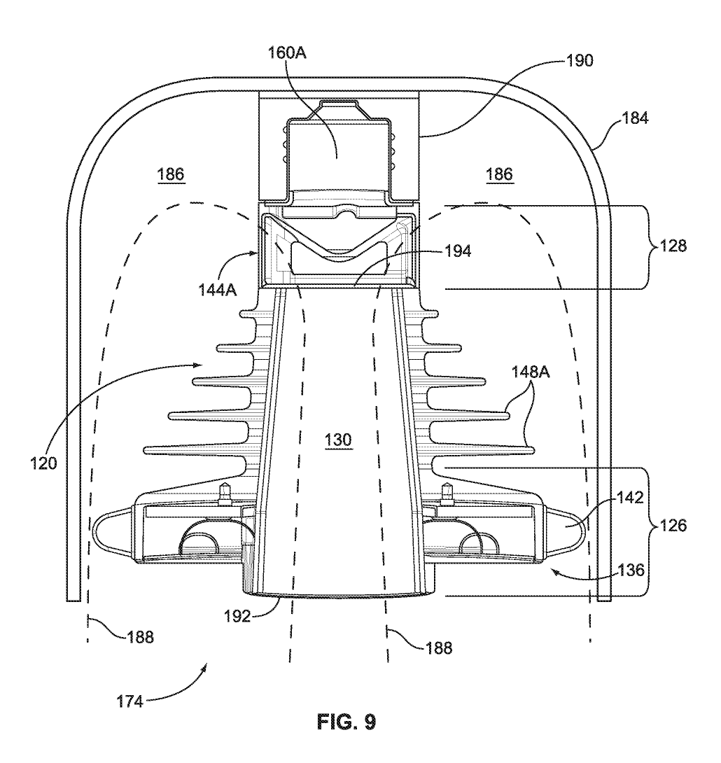

Referring to FIG. 9, in operation, a lamp 174 constructed according to a herein-disclosed embodiment may be installed into a socket 190 of a fixture 184. The lamp 174 is installed substantially vertically with the bottom end 128 of the heat sink 120 in a position higher than the top end 126 of the heat sink 120. However, in other embodiments the lamp 174 may not be installed substantially vertically, perhaps depending on the orientation and design of the fixture 184 in which it is installed.

Heat generated by the lamp is at least partially dissipated by the heat sink 120. At least a portion of the heat dissipated by the heat sink 120 may rise to an upper area 186 of the fixture 184. In this embodiment, the fixture 184 is closed near the upper area 186 of the fixture 184. In other embodiments, the fixture 184 may be at least partially open near the upper area 186 of the fixture 184.

The configuration of the airflow passageway 130 and its respective airflow openings 192, 194 facilitate the flow of air between the air adjacent the top end 126 and the air adjacent the bottom end 128 of the heat sink 120. As a result, heated air may flow through the airflow passageway 130 by means of natural convection. And active (i.e., forced) convection may be used as well. For instance, a partially mechanical device such as the above-mentioned fan 162 may be positioned near at least one of the airflow openings 192, 194.

In operation, air may generally flow along a path that is generally indicated at 188 in FIG. 9. And it is explicitly contemplated that, in any one or more embodiments, air may flow in either direction through the airflow passageway 130. Furthermore, according to some constructions of some embodiments, air may flow through the airflow passageway 130 in one direction during one time period (such as an initial time period) of operation, and may at a certain point reverse direction and flow through the airflow passageway 130 in the other direction during a second time period. In some embodiments, air that is heated near the top end 126 of the heat sink 120 may rise through the airflow passageway 130, as shown generally at the parts of the path 188 that are within the airflow passageway 130. That flowing air may then exit the lamp 174 through the deflector 144A, and may then displace a portion of the heated air that is in the upper area 186 of the fixture 184. This may force that displaced heated air to then exit the fixture 184 substantially near the top end 126 of the heat sink 120, as shown generally at the parts of the path 188 that are between the lamp 174 and the fixture 184.

### C. Conclusion

Various embodiments have been described above. Those skilled in the art will understand, however, that changes and modifications may be made to those examples without departing from the scope of the claims.

1. A heat sink for a lamp, the heat sink comprising:
a top end and a bottom end that is opposite the top end along a body axis of the heat sink;
an airflow passageway formed through the heat sink, the airflow passageway extending in general alignment with the body axis from substantially the top end of the heat sink to substantially the bottom end of the heat sink, the airflow passageway comprising at least one airflow opening located substantially at the top end of the heat sink and at least one airflow opening located substantially at the bottom end of the heat sink;
an internal surface that defines the airflow passageway; and
an external surface.

2. The heat sink of claim 1, further comprising an electronics mount positioned substantially at the top end of the heat sink, the electronics mount comprising a portion that is sized and shaped to receive an electronics module, wherein the electronics mount is configured such that at least some heat generated by the electronics module is transferred to the heat sink.

3. The heat sink of claim 2, the electronics mount further comprising an annular flange arranged about the airflow passageway and extending radially from the external surface of the heat sink.

4. The heat sink of claim 3, the electronics mount further comprising a rim that extends from the annular flange and is generally aligned with the body axis, the rim comprising an outer surface.

5. The heat sink of claim 4, the electronics mount further comprising at least one spacer extending radially from the outer surface of the rim.

6. The heat sink of claim 2, wherein the electronics module comprises at least one lighting element.

7. The heat sink of claim 6, wherein the at least one lighting element comprises at least one light emitting diode (LED).

8. The heat sink of claim 6, wherein the electronics module comprises a circuit board on which the at least one lighting element is arranged, the circuit board comprising circuitry electrically connected to the at least one lighting element.

9. The heat sink of claim 8, wherein the at least one lighting element comprises at least one light emitting diode (LED).

10. The heat sink of claim 1, wherein the airflow passageway is a single passageway.

11. The heat sink of claim 10, wherein the at least one airflow opening located substantially at the top end of the heat sink consists of a single airflow opening, and wherein the at least one airflow opening located substantially at the bottom end of the heat sink consists of a single airflow opening.

12. The heat sink of claim 11, wherein the airflow opening located substantially at the top end of the heat sink is larger than the airflow opening located substantially at the bottom end of the heat sink.

13. The heat sink of claim 1, wherein the airflow passageway comprises a plurality of passageways that are each generally aligned with the body axis.

14. The heat sink of claim 13, wherein the at least one airflow opening located substantially at the top end of the heat sink consists of a respective airflow opening for each passageway.

15. The heat sink of claim 14, wherein the at least one airflow opening located substantially at the bottom end of the heat sink consists of a respective airflow opening for each passageway, each passageway's respective airflow opening located substantially at the top end of the heat sink being larger than that passageway's airflow opening located substantially at the bottom end of the heat sink.

16. The heat sink of claim 14, wherein the at least one airflow opening located substantially at the bottom end of the heat sink consists of a single airflow opening.

17. The heat sink of claim 1, further comprising a deflector positioned substantially at the bottom end of the heat sink.

18. The heat sink of claim 17, wherein the deflector generally has a shape selected from the group consisting of a plate, a cone, and a cup.

19. The heat sink of claim 17, wherein the deflector is sized and shaped to receive a base for receiving input electrical power.

20. The heat sink of claim 19, wherein the base comprises at least one of an Edison-type base and a GU-type base.

21. The heat sink of claim 17, wherein the deflector is sized and shaped to receive electronics for conditioning input electrical power and for delivering conditioned electrical power for use by at least one lighting element.

22. The heat sink of claim 21, wherein the at least one lighting element comprises at least one light emitting diode (LED).

23. The heat sink of claim 1, further comprising a plurality of internal fins attached to and in thermal contact with the internal surface and extending therefrom.

24. The heat sink of claim 23, wherein each internal fin is generally aligned with the body axis.

25. The heat sink of claim 23, wherein at least one of the internal fins spans the airflow passageway.

26. The heat sink of claim 23, wherein at least one of the internal fins does not span the airflow passageway.

27. The heat sink of claim 1, further comprising a plurality of external fins attached to and in thermal contact with the external surface and extending radially therefrom.

28. The heat sink of claim 27, wherein each external fin lies in a different plane, each plane being generally normal to the body axis.

29. The heat sink of claim 28, wherein each external fin has a diameter, wherein the external fins generally have diameters less than that of any external fins that are closer to the top end of the heat sink.

30. The heat sink of claim 28, wherein the external fins are spaced regularly along a length of the heat sink between the top end of the heat sink and the bottom end of the heat sink.

31. The heat sink of claim 27, wherein each external fin lies in a different plane, each plane being generally aligned with the body axis.

32. The heat sink of claim 1, formed at least in part of a conductive material.

33. The heat sink of claim 32, wherein the conductive material comprises at least one material selected from the group consisting of aluminum, iron, copper, silver, gold, magnesium, zinc, and alloys thereof.

34. The heat sink of claim 1, wherein the heat sink is anodized.

35. The heat sink of claim 1, wherein the bottom end of the heat sink is sized and shaped to receive a partially mechanical device for accelerating air flow.

36. The heat sink of claim 35, wherein the partially mechanical device comprises a fan.

37. A lamp comprising:
a heat sink comprising (i) a top end and a bottom end that is opposite the top end along a body axis of the heat sink, (ii) an airflow passageway formed through the heat sink, the airflow passageway extending in general alignment with the body axis from substantially the top end of the heat sink to substantially the bottom end of the heat sink, the airflow passageway comprising at least one airflow opening located substantially at the top end of the heat sink and at least one airflow opening located substantially at the bottom end of the heat sink, (iii) an internal surface that defines the airflow passageway, and (iv) an external surface;
an electronics module positioned substantially at the top end of the heat sink, wherein the electronics module comprises at least one lighting element, and is configured such that at least some heat generated by the electronics module is transferred to the heat sink;
a base for receiving input electrical power, wherein the base is positioned substantially at the bottom end of the heat sink;
electronics for conditioning the input electrical power and for delivering conditioned electrical power for use by the at least one lighting element; and
at least one electrical connection for transmitting the conditioned electrical power to the at least one lighting element.

38. The lamp of claim 37, wherein the at least one lighting element comprises at least one light emitting diode (LED).

39. The lamp of claim 37, wherein the heat sink further comprises an electronics mount positioned substantially at the top end of the heat sink, the electronics mount comprising a portion that is sized and shaped to receive the electronics module.

40. The lamp of claim 37, wherein the electronics module comprises a circuit board on which the at least one lighting element is arranged, the circuit board comprising circuitry electrically connected to the at least one lighting element.

41. The lamp of claim 40, wherein the at least one lighting element comprises at least one light emitting diode (LED).

42. The lamp of claim 37, wherein the airflow passageway is a single passageway.

43. The lamp of claim 37, wherein the airflow passageway comprises a plurality of passageways that are each generally aligned with the body axis.

44. The lamp of claim 37, wherein the base comprises at least one of an Edison-type base and a GU-type base.

45. The lamp of claim 37, wherein the base is sized and shaped to receive the electronics for conditioning the input electrical power and for delivering conditioned electrical power for use by the at least one lighting element.

46. The lamp of claim 45, wherein the electronics for conditioning the input electrical power and for delivering conditioned electrical power for use by the at least one lighting element are positioned at least partially in the base.

47. The lamp of claim 37, wherein the heat sink further comprises a deflector positioned substantially at the bottom end of the heat sink.

48. The lamp of claim 47, wherein the deflector is sized and shaped to receive the electronics for conditioning the input electrical power and for delivering conditioned electrical power for use by the at least one lighting element.

49. The lamp of claim 47, wherein the deflector is sized and shaped to receive the base.

50. The lamp of claim 37, wherein the heat sink further comprises a plurality of internal fins attached to and in thermal contact with the internal surface of the heat sink and extending therefrom.

51. The lamp of claim 37, wherein the heat sink further comprises a plurality of external fins attached to and in thermal contact with the external surface of the heat sink and extending radially therefrom.

52. The lamp of claim 37, further comprising a partially mechanical device for accelerating air flow, the partially mechanical device positioned substantially at the bottom end of the heat sink.

53. The lamp of claim 52, wherein the partially mechanical device comprises a fan.

54. The lamp of claim 37, further comprising an optical lens positioned substantially at the top end of the heat sink, wherein the optical lens at least substantially covers the at least one lighting element.

55. A heat sink for a lamp, the heat sink comprising:
a top end and a bottom end that is opposite the top end along a body axis of the heat sink;
a single airflow passageway formed through the heat sink, the airflow passageway extending in general alignment with the body axis from substantially the top end of the heat sink to substantially the bottom end of the heat sink, the airflow passageway having a single airflow opening located substantially at the top end of the heat sink and a single airflow opening located substantially at the bottom end of the heat sink;
an internal surface that defines the airflow passageway;
an external surface;
a plurality of internal fins attached to and in thermal contact with the internal surface and extending therefrom;
a plurality of external fins attached to and in thermal contact with the external surface and extending radially therefrom;
a deflector positioned substantially at the bottom end of the heat sink; and
an electronics mount positioned substantially at the top end of the heat sink, the electronics mount comprising a portion that is sized and shaped to receive an electronics module, wherein the electronics mount is configured such that at least some heat generated by the electronics module is transferred to the heat sink.

56. The heat sink of claim 55, wherein the airflow opening located substantially at the top end of the heat sink is larger than the airflow opening located substantially at the bottom end of the heat sink.
